(19) United States
(12) Patent Application Publication
(10) Pub. No.: US 2011/0257956 A1
(43) Pub. Date: Oct. 20, 2011

(54) Modeling and Simulation of Power Environments

(75) Inventors: Ripal S. Goel, Plano, TX (US); Ron C. Williamson, Fullerton, CA (US)

(73) Assignee: Raytheon Company, Waltham, MA (US)

(21) Appl. No.: 13/086,919

(22) Filed: Apr. 14, 2011

Related U.S. Application Data
(60) Provisional application No. 61/324,189, filed on Apr. 14, 2010.
(60) Provisional application No. 61/324,206, filed on Apr. 14, 2010.

(51) Int. Cl. G06F 17/50

(52) U.S. Cl. 703/18

(57) ABSTRACT

In certain embodiments, a system includes one or more memory modules and one or more processing units. The one or more processing units access configuration parameters for configuring models that are operable to simulate operation of a power environment. A first subset of the models models power environment elements of the power environment. A second subset of the models models one or more external information sources, including an environmental source providing environmental data. The one or more processing units initiate configuration of the models according to the configuration parameters, resulting in configured models, and access operating parameters indicating operating conditions for the models to simulate. The one or more processing units initiate execution by the configured models of a simulation of the power environment according to the operating parameters. The configured models interact to execute the simulation. The simulation indicates how the simulated power environment behaves according to the operating parameters.

### RELATED APPLICATIONS

This application claims the benefit under 35 U.S.C. §119(e) of the priority of U.S. Provisional Application Ser. No. 61/324,189, filed Apr. 14, 2010, entitled “Power Grid Administration System” and U.S. Provisional Application Ser. No. 61/324,206, filed Apr. 14, 2010, entitled “Power Generation Modeling System.”

### BACKGROUND

Electrical power used by consumers, such as residential users, commercial users, government users, and industrial users, are typically provided by an electrical power grid. The electrical power grid generally includes multiple power generation stations that generate electrical power, and an electrical transmission/distribution system that delivers the generated electrical power to consumers.

### SUMMARY

In certain embodiments, a system includes one or more memory modules and one or more processing units. The one or more processing units access configuration parameters for configuring models that are operable to simulate operation of a power environment. A first subset of the models models power environment elements of the power environment. A second subset of the models models one or more external information sources, including an environmental source providing environmental data. The one or more processing units initiate configuration of the models according to the configuration parameters, resulting in configured models, and access operating parameters indicating operating conditions for the models to simulate. The one or more processing units initiate execution by the configured models of a simulation of the power environment according to the operating parameters. The configured models interact to execute the simulation. The simulation indicates how the simulated power environment behaves according to the operating parameters.

Certain embodiments of the present disclosure may provide one or more technical advantages. For example, certain embodiments provide simulations of a power environment and its elements that support non-renewable energy sources, renewable energy sources, energy management, and/or smart, autonomic grid behavior. Certain embodiments provide smart power environment models for an energy enterprise that spans multiple dimensions such as planning/evolution, operations, and interruptions. Certain embodiments provide interoperability using an abstraction layer such as a service-oriented architecture (SOA), allowing the modeling and simulation system to evaluate data from a variety of sources and to otherwise interact with a variety of heterogeneous systems, such as commercial off-the-shelf systems and/or live elements of a physical power environment. Certain embodiments may provide live, virtual, constructive simulation of a power environment such as a grid. Certain embodiments are able to model a self-aware or self-healing grid.

Embodiments of the present disclosure provide high-fidelity grid management and simulation that can be used for planning, analyzing smart grid operations, training, integrating with existing grid systems, and evaluating the performance of a grid system or other power environment. Certain embodiments provide for management and simulation of a smart energy enterprise (e.g., including renewable and non-renewable energy sources) that supports dynamic, autonomic smart grid capabilities. The modeling and simulation system may model the current state of the grid or other power environment, as well as the future state of the grid or other power environment. Certain embodiments allow users to perform analysis and trades that can be used for planning and evolution. Certain embodiments allow for easy configuration of models (e.g., storage, gensets, renewable energy sources, biofuels ICS, and others). The modeling and simulation system may integrate environmental factors such as weather fluctuations for renewable energy sources as part of modeling and simulating operation execution. Additionally or alternatively, certain embodiments integrate cost factors and feed-in-tariffs.

Certain embodiments allow a user to address “what-if” scenarios, such as cyber attacks, natural disasters, threats, outages, and other issues. For example, certain embodiments may provide enhanced robustness for power grids that may operate in hazardous regions, such as those in a military war zone. In many cases, power generation systems operating in a military war zone may be prone to attack either directly or remotely via cyber attack. Certain embodiments provide predictive models of various attack scenarios that a power environment may experience.

In certain embodiments, the present disclosure provides a common operating picture of a power grid while providing forecasting and energy management functions. Certain embodiments may provide techniques to forecast and provide energy management mixed with modeling and simulation.

Certain embodiments of the present disclosure may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

A more complete understanding of embodiments of the disclosure will be apparent from the detailed description taken in conjunction with the accompanying drawings in which:

FIG. 1 illustrates an example power management system for managing a power environment and for modeling and simulation of power environments, according to certain embodiments of the present disclosure;

FIG. 2 illustrates an example power environment management system for managing multiple microgrids and for modeling and simulation multiple microgrids, according to certain embodiments of the present disclosure;

FIG. 3 illustrates an example method for managing a power environment according to certain embodiments of the present disclosure; and

FIG. 4 illustrates an example method for modeling and simulating a power environment according to certain embodiments of the present disclosure.

### DESCRIPTION OF EXAMPLE EMBODIMENTS

Electrical power is typically provided by an electrical power system that administers the generation of electrical power and how this power is delivered to consumers. The power system may include electrical power generation stations that generate electrical power using differing forms of energy. Examples of energy sources used by electrical power generation stations may include, but are not limited to, renewable and non-renewable energy sources. Particular examples may include hydro-dynamic power that harnesses the energy of moving water, solar power that harnesses solar radiant energy, wind power, and/or natural gas, coal, or other fossil fuel energy sources.

Each of these power generation systems may have characteristics that make their use advantageous in certain scenarios. For example, power generation systems that use renewable energy, such as wind energy, or solar energy may be desired based upon their ecologically friendly use of resources; however, these sources of energy may be prohibitive based upon certain environmental conditions, such as on non-windy or cloudy days. Providing a computing framework capable of managing these often disparate types of power systems in an intelligent manner would be beneficial.

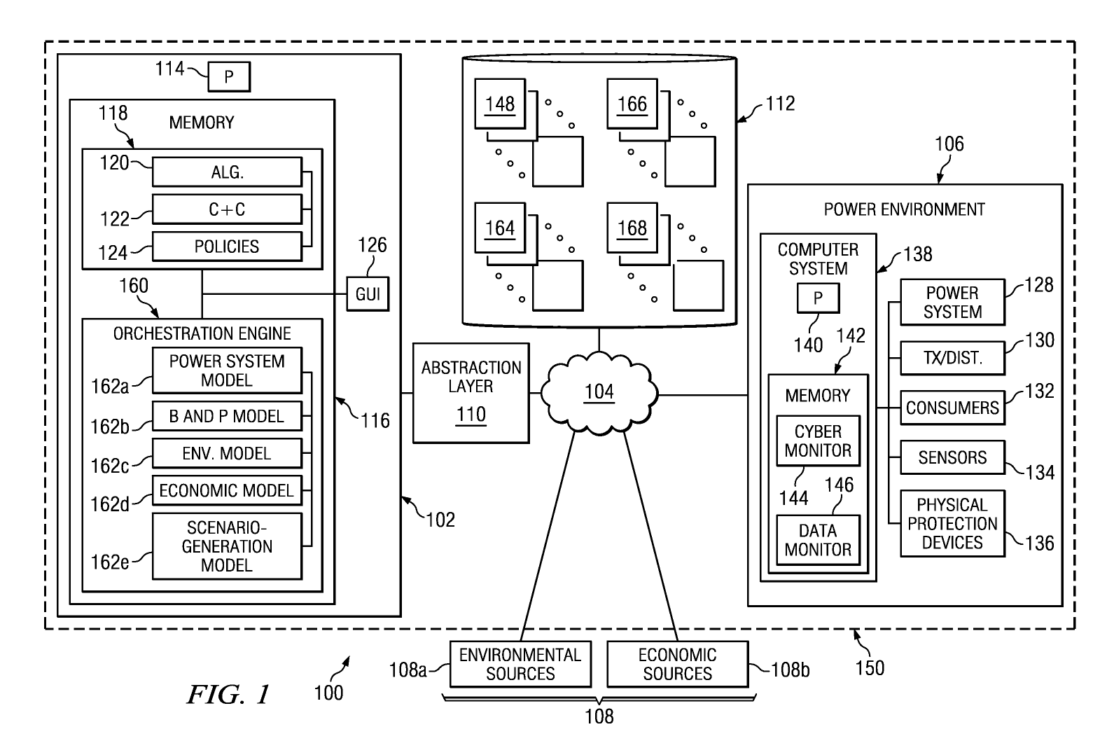

FIG. 1 illustrates an example power management system 100 for managing a power environment and for modeling and simulation of power environments, according to certain embodiments of the present disclosure. In the illustrated example, system 100 includes in part a management computing system 102, a network 104, a power environment 106, one or more external information sources 108, an abstraction layer 110, and a storage module 112. Although system 100 is described as including particular components, the present disclosure contemplates system 100 including any suitable components, according to particular needs.

Management computing system 102 may be implemented using any suitable type of processing system and may include any suitable combination of hardware, firmware, and software. For example, management computing system 102 may include one or more computer systems at one or more locations. Each computer system may include any appropriate input devices, output devices, mass storage media, processors, memory, or other suitable components for receiving, processing, storing, and communicating data. For example, each computer system may include a personal computer, workstation, network computer, kiosk, wireless data port, personal data assistant (PDA), one or more Internet Protocol (IP) telephones, smart phones, table computers, one or more servers, a server pool, one or more processors within these or other devices, or any other suitable processing device. Management computing system 102 may be a stand-alone computer or may be a part of a larger network of computers associated with an entity.

Management computing system 102 may include processing unit 114 and memory unit 116. Processing unit 114 may include one or more microprocessors, controllers, or any other suitable computing devices or resources. Processing unit 114 may work, either alone or with other components of system 100, to provide a portion or all of the functionality of system 100 described herein. Memory unit 116 may take the form of any suitable combination of volatile and non-volatile memory including, without limitation, magnetic media, optical media, RAM, ROM, removable media, and any other suitable memory component.

Management computing system 102 may be operable to facilitate management of power environment 106. For purposes of this description, management of power environment 106 may include operations such as viewing information about power environment 106, monitoring power environment 106, and controlling power environment 106. Management computing system 102 may be operable to perform some or all of these management operations automatically, substantially without or completely without human intervention. Additionally or alternatively, a human user may interact with management computing system 102 to direct the management of power environment 106.

Management computing system 102 may include a power management tool 118. For example, memory unit 116 of management computing system 102 may store a power management tool 118. Power management tool 118 may be implemented using any suitable combination of hardware, firmware, and software.

In general, power management tool 118 facilitates management of power environment 106 based on collected power management data. The collected power management data may include any suitable combination of operational data regarding elements of power environment 106, external data collected from one or more external information sources 108 (described below), and any other suitable data. In certain embodiments, a portion or all of power management tool 118 may be implemented as a service in a service-oriented architecture (SOA).

In the illustrated example, power management tool 118 includes one or more algorithms 120, a command and control module 122, and one or more policies 124. Power management tool may analyze the collected power management data using algorithms 120. Algorithms 120 may serve any suitable purpose. As just a few examples, algorithms may specify when and how graphical user interface (GUI) 126 (described below) should be updated, when to issue one or more commands to power environment 106 and the nature of the issued command, when and how to issue alert, and other suitable purposes. Algorithms may consult or otherwise interact with policies 124 to determine appropriate actions to perform in response to an analysis of collected power management data. Policies 124 may specify the frequency with which power management tool 118 analyzes collected power management data.

Command and control module 122 may provide a set of commands that may be issued to power environment 106, as well as functionality for issuing such commands. In certain embodiments, these commands include commands to adjust a status of one or more elements of power environment 106, turn on one or more elements of power environment 106, turn off one or more elements of power environment 106, and to perform other suitable actions.

Management computing system 102 may include a GUI 126, which may be generated by power management tool 118. As will be described in greater detail below, GUI 126 may display visualizations that may be useful for managing power environment 106. For example, these visualizations may provide a view of power environment 106, including potential some or all of the elements of power environment 106. As another example, these visualizations may provide a view (e.g., to a user of management computing system 102) of past, current, and/or potential future operational status of power environment 106. As another example, while certain functions provided by power management tool 118 may be automated (in some cases requiring little or no human intervention), in certain embodiments a user may manually intervene using GUI 126 to issue commands or otherwise reconfigure portions of system 100.

Components of system 100 may be communicatively coupled via a network 104. Network 104 facilitates wireless or wireline communication, and may communicate, for example, IP packets, Frame Relay frames, Asynchronous Transfer Mode (ATM) cells, voice, video, data, and other suitable information between network addresses. Network 104 may include one or more local area networks (LANs), radio access networks (RANs), metropolitan area networks (MANs), wide area networks (WANs), mobile networks (e.g., using WiMax (802.16), WiFi (802.11), 3G, 4G, or any other suitable wireless technologies in any suitable combination), all or a portion of the global computer network known as the Internet, and/or any other communication system or systems at one or more locations, any of which may be any suitable combination of wireless and wireline.

Power environment 106 may be an environment of elements that, among other things, is operable to generate and provide electrical power to consumers. Generally, power environment 106 and its constituent elements are the components being managed by management computing system 102. Power environment 106 may include any suitable combination of hardware, firmware, and software.

In the illustrated example, power environment 106 includes a number of elements. For example, power environment 106 includes a power system 128, one or more transmission/distribution devices 130, one or more consumers 132, one or more sensors 134, one or more physical protection devices 136, and one or more computer systems 138. Although power environment 106 is illustrated and described as including particular elements, the present disclosure contemplates power environment 106 comprising any suitable elements according to particular needs.

Power system 128 may include systems for, among other things, electricity generation, energy storage, and loads. Power system 128 may include any suitable combination of energy sources, such as renewable energy sources, non-renewable energy sources, alternate energy sources, a power utility grid, and any other suitable types of energy sources (some of which may overlap). Particular example energy sources for power system 128 may include fuel cells, wind, solar, hydroelectric, geothermal, biomass, biofuel, and any other suitable types of energy sources.

Transmission/distribution devices 130 provide the electrical power generated by power system 128 to consumers 132. Transmission/distribution devices 130 may include any suitable devices for facilitating the delivery of generated electrical power to consumers 132. For example, transmission/distribution devices 130 may include elements, such as transmission lines and/or one or more switch points that selectively interconnect power system 128 with consumers 132 that use electrical energy generated and/or stored by power system 128.

Consumers 132 may include any suitable consumers of the electrical power generated by power system 128. Reference to consumers may include any suitable combination of human consumers and devices/facilities that consume power. Consumers 132 may include any suitable combination of residential consumers, commercial consumers, government consumers, industrial consumers, and other types of consumers of electrical power.

Sensors 134 may include any suitable types of sensors, according to particular needs. In general, sensors 134 may monitor one or more conditions associated with power environment 106, such as by detecting occurrence of one or more events, detecting the presence of one or more conditions, and/or monitoring one or more conditions. Sensors 134 may be configured to report on a state or measurement (e.g., either proactively on a suitable schedule or according to a detected condition, or in response to being polled). Certain types of sensors 134 may be referred to as switches that are operable to initiate one or more actions or to detect a change in state. Example sensors may include any suitable combination of environmental sensors (e.g., temperature sensors, barometric pressure sensors, humidity sensors, water or other chemical sensors, wind speed, radiation sensors pressure difference sensors, and any other suitable types of environmental sensors), sensors for detecting operating conditions associated with power system 128, on/off switches, door open/close switches, check-in/check-out sensors, switches, motion sensors, fluid level sensors, infrared sensors, and any other suitable types of sensors.

Sensors 134 may be local to or remote from power environment 106. Some or all of sensors 134 may be located in or around the one or more premises that house power environment 106. Sensors 134 may communicate with computer system 138 in any suitable manner.

Physical protection devices 136 may include devices that protect, monitor, secure power environment 106 and its constituent elements. For example, physical protection devices 136 may include locks, access card scanners, security cameras, and other types of devices that physically protect power environment 106 and its constituent elements. Physical protection devices 136 may be programmed (possibly in combination with computer system 138) to generate alarms or other types of alerts upon the occurrence of certain events. Additionally or alternatively, physical protection devices 136 may log information associated with their operation.

Computer system 138 may be implemented using any suitable type of processing system and may include any suitable combination of hardware, firmware, and software. For example, computer system 138 may include one or more computer systems at one or more locations. Each computer system may include any appropriate input devices, output devices, mass storage media, processors, memory, or other suitable components for receiving, processing, storing, and communicating data. For example, each computer system may include a personal computer, workstation, network computer, kiosk, wireless data port, PDA, one or more IP telephones, smart phones, table computers, one or more servers, a server pool, one or more processors within these or other devices, or any other suitable processing device. Computer system 138 may be a stand-alone computer or may be a part of a larger network of computers associated with an entity.

Computer system 138 may include processing unit 140 and memory unit 142. Processing unit 140 may include one or more microprocessors, controllers, or any other suitable computing devices or resources. Processing unit 140 may work, either alone or with other components of system 100, to provide a portion or all of the functionality of system 100 described herein. Memory unit 142 may take the form of any suitable combination of volatile and non-volatile memory including, without limitation, magnetic media, optical media, RAM, ROM, removable media, and any other suitable memory component.

Computer system 138 may include a cyber monitoring module 144. Cyber monitoring module 144 may be implemented using any suitable combination of hardware, firmware, and software. Cyber monitoring module 144 may be operable to monitor computer system 138 and other elements of power environment 106 for possible cyber attacks or other security issues, to detect cyber security vulnerabilities, and to perform other suitable security monitoring, detection, and analysis. Cyber monitoring module 144 may be programmed to generate alarms or other types of alerts upon the occurrence of certain events. Additionally or alternatively, cyber monitoring module 144 may log information associated with its operation, such as the occurrence and result of any scans, the detection of events, and other suitable information.

Computer system 138 may include a data monitor 146, which may be implemented using any suitable combination of hardware, firmware, and software. Data monitor 146 may be operable to monitor other elements of power environment 106 for operating data and to handle communications with management computing system 104. In certain embodiments, data monitor 146 is able to communicate with various elements of power environment 106 in a format understandable to those particular elements.

System 100 may include one or more external information sources 108 that may provide data useable by management computing system 102 to perform its associated management functions. External information sources 108 may provide information external to managed power environment 106 that may be useful in evaluating past, present, and future conditions associated with managing power environment 106. In certain embodiments, external information sources 108 include one or more of environmental sources 108a and economic sources 108b, though the present disclosure contemplates system 100 including any suitable number and types of external information sources 108.

External environmental sources 108a may include web sites, web services, and/or other suitable sources of information regarding environmental conditions. These environmental conditions may include, for example, past, present, and/or future weather conditions. Other example environmental conditions may include past, present, and/or future natural disaster conditions (which, if appropriate, may overlap weather conditions). A particular example external environmental source 108a may include a database, web site, and/or web service provided by the United States National Oceanic and Atmospheric Administration (NOAA).

External economic sources 108b may include web sites, web services, and/or other suitable sources of information regarding economic conditions. These economic conditions may include, for example, past, present, and/or future economic conditions. Particular example economic information may include feed-in-tariffs (FiT). A feed-in-tariff may include a policy mechanism for encouraging the adoption of renewable energy sources and/or for facilitating the acceleration a move toward “grid parity.” In certain situations, FiTs include one or more of the following provisions: (1) guaranteed grid access; (2) long-term contracts for the electricity produced; and (3) purchase prices that are based on the cost of renewable energy generation and encourage toward grid parity. A particular example external economic source 108b may include a database, web site, and/or web service adapted to provide FiT information.

Different types of power environments 106 may be implemented in different ways using different elements. For example, a first power environment 106 may be implemented using a first combination of hardware components while a second power environment 106 may be implemented using a different second combination of hardware. As a more particular example, a first power environment 106 may be implemented using a power system 128 that uses a non-renewable energy source while a second power environment may use a power system 128 that uses a renewable energy source. Even within these two types of power sources (i.e., non-renewable and renewable), the particular types of energy sources may use different hardware (and possibly other elements) to implement power environment 106.

In other words, different power environments 106 may be heterogeneous. In certain embodiments, the term “heterogeneous” means that different power environments 106 may be associated with different power sources and/or include different combinations of hardware, firmware, and software, possibly provided by different vendors. Each power environment 106 may be associated with its own management operations and format for implementing those management operations. For example, issuing commands to elements of a first power environment 106 may be implemented in a different way than issuing similar commands to elements of a second power environment 106. However, many operations and other management functions may be common (though implemented differently), across different power environments 106. Additionally, different power environments 106 may have varying scales or may be scalable such that the size of the power environment 106 may change over time.

It may be desirable to provide a framework for managing heterogeneous types of power environments 106 using an abstracted, common set of operations. This may facilitate a more flexible, dynamic, and automated system for managing various types of power environments 106. Each power environment 106 and its associated elements may describe power management in different ways. For example, each element may have different descriptions, different interfaces (e.g., APIs), different inputs, different outputs, and different methods to communicate. However, these multiple elements may provide a substantially similar set of functionality and data elements for power management. As will be described in more detail below, these similarities may be leveraged to abstract from the environment-specific solutions to provide a substantially uniform way of interacting with power environments 106 of different types.

In addition to heterogeneous power environments 106, different types of external information sources 108 may present their associated information in different ways. For example, a first external information source 108 may be a web service that presents information according to a specified interface specification, while a second external information source 108 may be a SQL database that is queried using SQL queries.

Embodiments of the present disclosure provide an abstraction layer 110 for managing heterogeneous power environments 106 and for interacting with heterogeneous of external information sources 108. Abstraction layer 110 may provide an abstracted set of operations for managing heterogeneous types of power environments 106. Abstraction layer 110 may provide abstracted methods for messaging, collecting and storing data values, issuing commands, and other suitable functions across heterogeneous power environments 106. Abstraction layer 110 may be implemented using any suitable combination of hardware, firmware, and software.

One example technique for implementing abstraction layer 110 and its associated abstracted functionality is using a SOA. For example, abstraction layer 110 may be implemented using a SOA bus and one or more SOA interfaces (e.g., a SOA interface associated with management computing system 102 for interacting with the SOA bus, and a SOA interface associated with computer system 138 for interacting with the SOA bus).

In certain embodiments, abstraction layer 110 may allow management computing system 102 reduce or eliminate the coupling of management computing system 102 to the particular elements (e.g., energy sources and the hardware, firmware, and software) of a particular power environment 106, or to a particular scale of power environment 106. Instead, certain embodiments provide an abstracted layer of interaction functions that may be used across heterogeneous power environments 106. Example abstracted messages that may be implemented by abstraction layer 110 may include commands, request for collection of power management data (e.g., status requests and requests for operational parameters), responses to requests for collection of power management data (e.g., the provision of power management data), warnings or other alerts, and any other suitable information.

Although illustrated primarily as a distinct component of system 100, the present disclosure contemplates implementing abstraction layer 110 in any suitable manner. For example, portions or all of abstraction layer 110 may be implemented using any suitable combination of management computing system 102 (e.g., using power management tool 116), computer system 138 (e.g., data monitor 146) of power environment 106, external information sources 108, and a computer system implementing abstraction layer 110.

In certain embodiments, management computing system 102 may implement a portion of abstraction layer 110. For example, management computing system 102 may include a number of software adapters that are operable to translate data from a first format that is specific to a particular element of management computer system 102 and/or power environment 106 to an abstract format that can be used for messaging and data storage across different types of elements, and vice versa if appropriate. Additionally or alternatively, in certain embodiments, computer system 138 may implement a portion of abstraction layer 110. For example, computer system 138 may include a number of software adapters that are operable to translate data from a first format that is specific to a particular element of management computer system 102 and/or power environment 106 to an abstract format that can be used for messaging and data storage across different types of elements, and vice versa if appropriate. Any of these examples can be used in any suitable combination.

As a particular example, abstraction layer 110 is implemented using a combination of management computing system 102 and computer system 138 of power environment 106. In this example, management computing system 102 includes a number of software adapters that are operable to translate data from a format that is specific to a particular element of management computer system 102 (e.g., from a format associated with command and control module 122) to an abstract format that can be used for messaging and data storage across different types of elements. In this example, these adapters may also be able to translate data received from external information sources 108 from a format that is specific to a particular external information source 108 to an abstract format that can be used for representing common types of external data received from different external information sources (e.g., weather data). In this example, computer system 138 includes a number of software adapters that are operable to translate data both from a format that is specific to a particular element of power environment 106 to an abstract format that can be used for messaging and data storage across different types of elements, as well as from the abstract format to a format that is specific to a particular element of power environment 106. Although this particular example has been described, the present disclosure contemplates implementing the features and operation of abstraction layer 110 in any suitable manner, according to particular needs.

While abstraction layer 110 has been illustrated as being implemented in a particular manner, the present disclosure contemplates implementing abstraction layer 110 in any suitable manner. Furthermore, although SOA is described as a technique for implementing abstraction layer 110, the present disclosure contemplates using any suitable technique for implementing abstraction layer 110.

In embodiments in which abstraction layer 110 is implemented using SOA, abstraction layer 110 may comprise a SOA bus. As just one example, a SOA bus may be implemented as an enterprise service bus (ESB). The ESB may represent software that lies between applications/devices associated with management computing system 102 and applications/devices associated with power environment 106/external information sources 108 and implements communication among those components. In certain embodiments, the ESB may replace direct communication among these components such that communication takes place using the ESB. To provide this capability, the ESB may encapsulate the functionality offered by its component applications in an abstracted manner, possibly using a message model. The message model may define an abstracted set of messages that the ESB may transmit/receive, which may be standard across different types of power environments 106/external information sources 108. The ESB may also handle routing messages to appropriate applications or other destinations. Since messages communicated among components of system 100 may be formatted in a manner that is not according to the standard message format implemented by the ESB, the ESB or some other suitable component of system 100 may translate the messages into the standard format. Components such as adapters may perform this translation.

In certain embodiments, each computer system 138 exposes a SOA-based interface that provides information to management computing system 102 (e.g., power management tool 118) and/or accept command (or other) messages from management computing system 102 (e.g., power management tool 118). An SOA may include services that each includes an executable segment of code that provides a specified function. In certain embodiments, the function provided by each service has a level of granularity sufficient for management of power environment 106 by management computing system 102 (e.g., power management tool 118). In certain embodiments, the services may be administered through an ESB. The ESB may orchestrate multiple services together to provide one or more business applications, which in this particular application, is a power generation administration tool 22 that may be used to manage power environment 106.

Certain embodiments incorporating an SOA may provide an advantage in that a control system may be implemented on existing elements of power environment 106 in a relatively efficient manner. For example, services implemented by the SOA interface may expose information about its associated power environment 106 in a relatively concise manner such sensitive information is not inadvertently leaked in an uncontrolled manner. Thus, managers of individual power environments 106 may be able to expose only those characteristics of their power environment 106 that does not include sensitive information. Additionally, the SOA interface may provide a relatively extensible system in which new and/or additional power environments 106 (or elements within a particular power environment 106) may be easily managed by the same or a different power management tool 118. In certain embodiments, the SOA or other abstraction layer 110 may also allow other commercial-off-the-shelf products to be plugged into system 100 with relative ease, whether from the management computing system 102 perspective, the power environment 104 perspective, and/or the external information sources 108 perspective.

System 100 may include storage module 112. Storage module 112 may take the form of any suitable combination of volatile or non-volatile memory including, without limitation, magnetic media, optical media, RAM, ROM, removable media, or any other suitable memory component. In certain embodiments, a portion of all of storage module 112 may include a database, such as one or more SQL servers or relational databases. Storage module 112 may be a part of or distinct from memory unit 116 of management computing system 102. The present disclosure contemplates storage module 112 being divided into any suitable number and types of storage modules.

Storage module 112 may store a variety of data that may be used by management computing system 102 (e.g., power management tool 118) to manage power environment 106. Although storage module 112 is described as including particular information in particular formats, storage module 112 may store any other suitable information and may store information in any suitable format. Furthermore, although particular information is described as being stored in storage module 112, the present disclosure contemplates storing this information in any suitable location, according to particular needs.

Storage module 112 may store data collected from power environment 106 and from external information sources 108 as well as data generated by power management tool 118, which collectively may be referred to as power management data 148. Power management data 148 may be used by management computing system 102 (e.g., power management tool 118) for use in managing power environment 106. For example, power management data 148 may include operational data related to the operation of elements of power environment 106. As another example, power management data 148 may include environmental data. Environmental data may be provided by sensors located at the power environment (e.g., temperature sensors, barometric pressure sensors, radiation sensors, or any other suitable types of sensors for detecting environmental conditions). Additionally, environmental data may be provided by external environmental sources 108a. As another example, power management data 148 may include economic data from economic sources 108b. The economic data may include, for example, data regarding FiTs. The stored power management data 148 may include any suitable combination of past, present, and forecasted data. In the case of forecasted data, such data may be generated or otherwise determined by management computing system 102.

Storage module 112 may store power management data 148 in any suitable manner, according to particular needs. In certain embodiments, storage module 112 stores a number of software objects, which may store appropriate power management data 148. Each object may represent one or more elements of power environment 106 and/or external information sources 108, or other suitable entities for which data may be stored. The objects may be organized according to any suitable class hierarchy or other suitable arrangement. Power management data 148 may be stored in software objects representing various elements of power environment 106 and or other suitable elements of system 100 that correspond to the element corresponding to the power management data 148.

In certain embodiments, the collection of one or more elements of system 100 forms what may be referred to as a microgrid 150. In the illustrated example, power management system 102, a portion or all of network 104, power environment 106, abstraction layer 110, and storage module 112 form microgrid 150. It should be understood that this particular collection of elements is provided for example purposes only. Microgrid 150 may include other suitable combinations of elements of system 100, as well as elements not illustrated. Additionally, a microgrid is just one example of an entity that may be formed by these elements.

In operation of an example embodiment of system 100, power management tool 118 is operable to administer the operation of power environment 106 based on power management data 148 received from power environment 106 and/or external information sources 108. For example, power management tool 118 may analyze power management data 148 according to one or more algorithms 120 and policies 124, and may determine whether to perform one or more actions based on the analysis and if so, what one or more actions to perform. Power management tool 118 may be able to perform some or all of these actions substantially autonomically, without requiring the input of a human user, thereby providing smart, autonomous management of heterogeneous types of power environments 106. As described above, the power management data received from power environment 106 (e.g., operational data) and external information sources 108 (e.g., environmental data and/or economic data) may be translated from a format associated with their native elements into an abstract format implemented using abstraction layer 110.

Returning to management computing system 102, in certain embodiments, management computing system 102 includes a modeling and orchestration engine 160 (referenced throughout the remainder of this description as orchestration engine 160) that is operable to simulate operation of a power environment (that may or may not correspond to power environment 106). The power environment for which simulation is being performed may be a power environment under design and/or testing, which will be referenced throughout this description as an evaluated power environment. Some or all of the elements of the evaluated power environment may not actually be implemented or installed, but may be represented through a variety of models, described below. Thus, although system 100 includes power environment 106, the present disclosure contemplates management computing system 102 including orchestration engine 160 and not having access (either permanently or temporarily) to a physical power environment 106. Additionally or alternatively, an evaluated power environment may include actual physical elements of an existing power environment 106, if appropriate. Orchestration engine 160 may be implemented using any suitable combination of hardware, firmware, and software.

Orchestration engine 160 may include a plurality of models 162. In certain embodiments, models 162 are implemented using any suitable combination of simulation software, numerical analysis software, or other suitable types of modeling and/or simulation software. For example, models 162 may be implemented using any suitable combination of MATLAB by MATHWORKS, SIMULINK by MATHWORKS, EXTENDSIM by IMAGINE THAT INC., AUTOMATED COST ESTIMATING INTEGRATED TOOLS (ACEIT) by TECOLETE RESEARCH, INC., and any other suitable types of modeling and/or simulation software.

Particular example types of models 162 that may be included in system 100 are described below. Although orchestration engine 160 is illustrated and described as including particular types of models, the present disclosure contemplates orchestration engine including any suitable types of models, according to particular needs. Furthermore, although models 162 are illustrated as being stored in memory unit 116, the present disclosure contemplates a portion or all of models 162 being stored in any other suitable location. Any of the below-described models 162 may contain any suitable number of models, according to particular needs.

Model 162a comprises a power system model, which will be referenced as power system model 162a. Power system model 162a may model the components, such as the power and electronics, of the power system of the evaluated power environment. For example, power system model 162a may include power generation models, power storage models, power load models, power transmission/distribution models, and any other suitable types of models.

Model 162b comprises a behavioral and performance model, which will be referenced as behavioral and performance model 162b. Behavioral and performance model 162b may be operable to model how the evaluated power environment behaves in response to various commands and/or conditions. In certain embodiments, behavioral and performance model 162b may interact with scenario-generation model 162e to perform its analysis.

Model 162c comprises an environmental model, which will be referenced as environmental model 162c. Environment model 162c may model various types of environmental data. For example, environmental model 162c may model past, present, and/or future weather conditions; past, present, and/or future natural disaster conditions (which, if appropriate, may overlap weather conditions); and any other suitable environmental conditions. A portion or all of the data used by environmental model 162c to perform its analysis may be retrieved from external information sources 110, and in particular environmental sources 110a. Other example sources of environmental data for consideration by environmental model 162c may include sensors 134 associated with an actual power environment 106, if appropriate.

Model 162d comprises an economic model, which will be referenced as economic model 162d. Economic model 162d may model various types of economic data. For example, economic model 162d may model past, present, and/or future cost data; past, present, and/or future FiT data; and any other suitable economic conditions. A portion or all of the data used by economic model 162d to perform its analysis may be retrieved from external information sources 110, and in particular economic sources 110b. In certain embodiments, a separate cost model for each type of power source used in the evaluated power environment may be implemented. For example, if the evaluated power environment includes both renewable and non-renewable energy sources, separate cost models may be implemented for each of these types of energy sources. In certain embodiments, even within a particular one of these types of energy sources (e.g., renewable and non-renewable energy sources) separate costs models may be implemented for each particular type of energy source used in the evaluated power environment.

Model 162e comprises a scenario-generation model, which will be referenced as scenario-generation model 162e. Scenario-generation model 162e may be used to implement various “what-if” scenarios that may be used to evaluate the evaluated power environment. For example, some example scenarios implemented by scenario-generation model 162e may include cyber attacks, natural disasters, power outages, security threats, and other suitable for which it may be desirable to evaluate the evaluated power environment.

As a particular example, model 162e may target a potential susceptibility of the evaluated power environment to a cyber attack. As another particular example, model 162e may target a potential susceptibility of the evaluated power environment to a natural disaster of some type. Evaluating the effects of these possible scenarios may allow a designer of the evaluated power environment to adjust system settings or otherwise make design changes that may improve the ability of the evaluated power environment to deal with these possible scenarios while reducing or eliminating negative effects.

Any suitable combination of these models and other (or different) models 162 may be used to effect the simulation of an evaluated power environment. In certain embodiments, models 162 are operable to interact with one another through the simulation to generate the simulation results. If appropriate, orchestration engine 160 and/or abstraction layer 110 may coordinate or otherwise facilitate the interaction of models 162 in performing a simulation.

Storage module 112 may store a variety of information for use by orchestration engine 160 in performing the modeling and simulation. Although this information is described as being stored in storage module 112, the present disclosure contemplates system 100 storing this information in any suitable location, according to particular needs. Additionally, although particular information is described as being stored for use by orchestration engine 160, the present disclosure contemplates system 100 storing any suitable information for use by orchestration engine 160.

Storage module 112 may store configuration parameters 164. Configuration parameters 164 may be provided by a user of management computing system 102 and may specify the configuration of the evaluated power environment. In certain embodiments, configuration parameters 164 indicated a set of power environment elements to be included in the evaluated power environment. For example, configuration parameters 164 may specify for an evaluated power environment one or more types of cyber monitoring modules, power systems, transmission/distribution devices, consumers, sensors, and physical protection devices.

Configuration parameters 164 may be used by orchestration engine 160 to select which models 162 to use for performing a simulation, and at least partly how those selected models should be configured. As particular examples, configuration parameters 164 may specify the particular power sources of a power system, particular transmission/distribution devices, particular numbers and/or types of consumers, particular cyber monitoring software, and other suitable configurations associated with the evaluated power environment. Power system may include any suitable combination of energy sources, such as renewable energy sources, non-renewable energy sources, alternate energy sources, a power utility grid, and any other suitable types of energy sources (some of which may overlap). Particular example energy sources for power system 128 may include fuel cells, wind, solar, hydroelectric, geothermal, biomass, biofuel, and any other suitable types of energy sources. Configuration parameters 164 may also specify a variety of thresholds and optimization criteria for use in configuring models 162.

Storage module 112 may store operating parameters 166. Operating parameters 166 may be provided by a user of management computing system 102 and may indicate operating conditions for models 162 to simulate. For example, operating parameters 166 indicate one or more scenarios of scenario-generation model 162e that should be used for simulating events with respect to the evaluated power environment. In certain embodiments, operating parameters 166 comprise an indication of a simulation time period for simulating operation of the evaluated power environment. The results of the simulation of the evaluated power environment may reflect how the evaluated power environment behaved in the simulation over the simulated time period. As a particular example, operating parameters 166 may specify that an evaluated power environment should be tested over a simulated time period of three years to simulate how the evaluated environment may perform over that time period.

One or more of configuration parameters 164 and operating parameters 166 may specify which, if any, external information sources 108 should be used to configure models 162 and/or implement the simulation of the evaluated power environment. For example, these parameters may specify that certain environmental data (e.g., past, current, and/or forecasted weather data) should be used by one or more models 162 to implement the simulation of the evaluated power environment. As another example, these parameters may specify that certain economic data (e.g., cost data and/or FiT data) should be used by one or more models 162 to implement the simulation of the evaluated power environment. This external data may be retrieved from external information sources 108 using abstraction layer 110.

Storage module 112 may store simulation results data 168. Simulation results data 168 may be analyzed by orchestration engine 160 to generate suitable output for display on GUI 126. This output may allow a user to view the results of the simulation, operating conditions or other configuration information implemented through the simulation, present and future state of the evaluated power environment, and any other suitable information. In certain embodiments, simulation results data 168 may be generated by one or more of models 162, individually or collectively. Some of these may modify settings specified by the configuration parameters and/or be used to determine the effect on the parameters specified.

In general, orchestration engine 160 is operable to configure models 162 according to configuration parameters 164, and to run simulations on an evaluated power environment using the configured models 162 based on operating parameters 164. These simulations may result in simulation results 168 that may be stored in storage module 112. Simulations generated by models 162 may model one or more of the present state of the evaluated power environment and the future state of the evaluated power environment. Models 162 may interact with one another in implemented the simulation and generating simulation results. Orchestration engine 160 may receive separate simulation results 168 from each model 162, models 162 may coordinate to generate a single set of simulation results 168, and/or one or more models 162 may store results directly in storage module 112.

Certain types of simulation may involve issuing commands to the evaluated power environment. For example, orchestration engine 160 may receive one or more commands from a user of management computing system 102. As another example, one or more of models 162 invoked as part of the simulation may autonomically request issuance of a command.

If orchestration engine 160 determines at step 412 to issue a command, then at step 414 orchestration engine 160 may initiate issuance of a command to the evaluated power environment being simulated. In certain embodiments, orchestration engine 160 may issue commands by invoking power management tool 118 (e.g., command and control module 122) to issue the commands. Commands may be issued in an abstracted format using abstraction layer 110, when a physical power environment 106 is involved in the simulation for example. Incorporating a physical power environment 106 into a simulation may allow for live simulation of an evaluated power environment (e.g., power environment 106).

Orchestration engine 160, models 162, storage module 112, and external information sources 108 may be operable to communicate via abstraction layer 110, which may provide a common, abstracted messaging format usable for communication between or among these components of system 100. Taking external information sources 108 as an example, based on configuration parameters 164 and/or operating parameters 166, orchestration engine 160 may determine that one or more models 162 should use external data retrieved from one or more external information sources 108 in performing their analysis. For example in simulating operation of a particular evaluated power environment over the next seven-day period, one or more of models 162 may consider forecasted weather data for the next seven days, as received from environmental sources 108a (e.g., possibly via abstraction layer 110). Using abstraction layer 110, orchestration engine 160 may request weather forecasted weather data from environmental source 108a.

In certain embodiments, orchestration engine 160 may generate a GUI 126 based on simulation results 168. Additionally or alternatively, orchestration engine 160 may generate GUI 126 to include a representation of configuration parameters 164 and/or operating parameters 166. Generating GUI 126 may include generated an initial GUI 126 or updating an existing GUI 126. The simulation of the evaluated power environment, possibly in conjunction with GUI 126, may provide an indication of how the simulated, evaluated power environment behaves according to the operating parameters, commands, and/or other factors.

Portions of system 100 may include logic contained within a computer-readable medium. Logic may include hardware, software, and/or other logic. The medium in which the logic is encoded may include a tangible medium. The logic may perform operations when executed by a processor (e.g., processing unit 114 and/or processing unit 140). Certain logic may include a computer program, software, computer executable instructions, and/or instructions capable being executed by a processor (e.g., processing unit 114 and/or processing unit 140). The logic may also be embedded within any other suitable medium without departing from the scope of the disclosure.

For example, power management tool 118, abstraction layer 110, cyber monitor 144, and data monitor 146, orchestration engine 160, as well as other suitable components of system 100, may include executable code stored in a memory module and executed by a processor (e.g., of a computer system). The executable code may be implemented using any suitable programming language or platform and may communicate with computing platforms in any suitable manner. In certain embodiments, management computing system 102 and computer system 138 execute multiple services operating in a SOA for communicating information between one another.

Modifications, additions, or omissions may be made to power administration system 100 without departing from the scope of the disclosure. The components of power administration system 100 may be integrated or separated. For example, management computing system 102 and computer system 138 local to or remote from the elements of power environment 106 that they manage. Moreover, the operations of power administration system 100 may be performed by more, fewer, or other components.

Certain embodiments of the present disclosure may provide one or more technical advantages. For example, certain embodiments may provide enhanced visualization of one or more managed power environments through a GUI 126. These visualizations may provide dynamic situational awareness of one or more managed power environments 106. As another example, certain embodiments may provide intelligent, autonomic management of one or more power environments 106. As another example, certain embodiments may provide a framework that is interoperable among a number of heterogeneous power environments 106 and/or microgrids 150. As a particular example, certain embodiments may implement a SOA or other abstraction layer 110 that abstracts various operations across heterogeneous power environments 106. Certain embodiments combine supervisory control and data acquisition (SCADA) with an energy management system (EMS) to provide an intelligent and sometimes automated framework for managing power environments 106, and that provides a common operating picture of the managed power environment 106. As another example, certain embodiments support adjacent energy markets, such as both renewable and non-renewable energy markets.

Certain embodiment of power administration system 100 may provide enhanced robustness for power environments 106 that may operate in hazardous regions, such as those in a military war zone. In many cases, power environments 106 operating in a military war zone may be prone to attack either directly or remotely via cyber attack. Management computing system 102 may receive substantially real-time operating status information from elements configured in a power environment 106 and adjusts operation of the elements to mitigate outages (or other issues) that may be experienced by certain power environment elements that are prone to attack. A power management tool 118 may provide an energy management and control (M&C) system for a microgrid 150 that may be self-aware and/or self-healing.

Certain embodiments may provide simulations of a power environment and its elements that support non-renewable energy sources, renewable energy sources, energy management, and/or smart, autonomic grid behavior. Certain embodiments provide smart power environment models 162 for an energy enterprise that spans multiple dimensions such as planning/evolution, operations, and interruptions. Certain embodiments provide interoperability using an abstraction layer 110, such as a SOA, allowing the modeling and simulation system to evaluate data from a variety of sources and to otherwise interact with a variety of heterogeneous systems, such as commercial off-the-shelf systems and/or live elements of a physical power environment 106. Certain embodiments may provide live, virtual, constructive simulation of a power environment such as a grid. Certain embodiments are able to model a self-aware or self-healing grid.

Embodiments of the present disclosure provide high-fidelity grid management and simulation that can be used for planning, analyzing smart grid operations, training, integrating with existing grid systems, and evaluating the performance of a grid system or other power environment. Certain embodiments provide for management and simulation of a smart energy enterprise (e.g., including renewable and non-renewable energy sources) that supports dynamic, autonomic smart grid capabilities. The modeling and simulation system may model the current state of the grid or other power environment, as well as the future state of the grid or other power environment. Certain embodiments allow users to perform analysis and trades that can be used for planning and evolution. Certain embodiments allow for easy configuration of models 162 (e.g., storage, gensets, renewable energy sources, biofuels ICS, and others). The modeling and simulation system may integrate environmental factors such as weather fluctuations for renewable energy sources as part of modeling and simulating operation execution. Additionally or alternatively, certain embodiments integrate cost factors and feed-in-tariffs.

Certain embodiments allow a user to address “what-if” scenarios, such as cyber attacks, natural disasters, threats, outages, and other issues. For example, certain embodiments may provide enhanced robustness for power grids that may operate in hazardous regions, such as those in a military war zone. In many cases, power generation systems operating in a military war zone may be prone to attack either directly or remotely via cyber attack. Certain embodiments provide predictive models of various attack scenarios that a power environment may experience.

In certain embodiments, the present disclosure provides a common operating picture of a power grid while providing forecasting and energy management functions. Certain embodiments may provide techniques to forecast and provide energy management mixed with modeling and simulation.

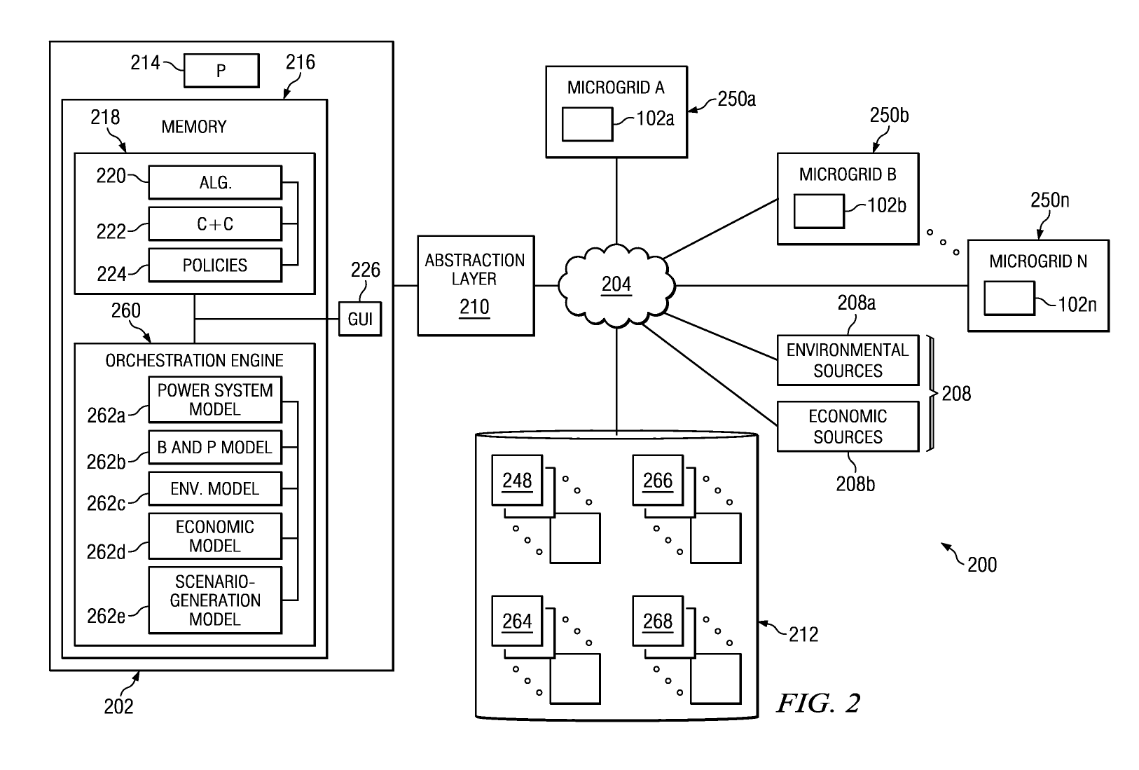

FIG. 2 illustrates an example power environment management system 200 for managing multiple microgrids and for modeling and simulation multiple microgrids, according to certain embodiments of the present disclosure. In the illustrated example, system 200 includes management computing system 202, network 204, microgrids 250, external information sources 208, abstraction layer 210, and storage module 212.

Management computing system 202 may be the same as and/or may share certain or all features in common with management computing system 102 of FIG. 1. Management computing system 202 may be used for managing multiple microgrids 250. It should be understood that in certain embodiments, even management computing system 102 of FIG. 1 may be capable of managing multiple microgrids 150 (or 250), if appropriate. The components of management computing system 202 (e.g., processing unit 214, memory unit 216, power management tool 218, algorithms 220, command and control module 222, policies 224, and GUI 226) may be the same as and/or share certain or all features in common with the components of management computing system 102 (e.g., processing unit 114, memory unit 116, power management tool 118, algorithms 120, command and control module 122, policies 124, and GUI 126) of FIG. 1.

Components of system 200 may be communicatively coupled via a network 206. Network 206 may be the same as and/or may share certain or all features in common with network 104 of FIG. 1. Network 206 facilitates wireless or wireline communication, and may communicate, for example, IP packets, Frame Relay frames, ATM cells, voice, video, data, and other suitable information between network addresses. Network 206 may include one or more LANs, RANs, MANs, WANs, mobile networks (e.g., using WiMax (802.16), WiFi (802.11), 3G, 4G, or any other suitable wireless technologies in any suitable combination), all or a portion of the global computer network known as the Internet, and/or any other communication system or systems at one or more locations, any of which may be any suitable combination of wireless and wireline. Portions or all of network 206 may be the same as or different from portions or all of network 104.

System 200 includes a number of microgrids 250. Each microgrid 250 may be the same as and/or may share certain or all features in common with microgrid 150 of FIG. 1. In certain embodiments, each microgrid 250 is associated with its own management computing system 102 (e.g., as illustrated in FIG. 1 where microgrid 150 is associated with management computing system 102). Microgrids 250 may or may not be heterogeneous. These management computing systems 102 may then report to a higher level management computing system 202. It should be noted that one of the management computing systems 102 of one of the microgrids 250 also may serve as this “higher level” management computing system 202, if appropriate. The microgrids 250 managed using management computing system 202 may be considered a cluster of microgrids 208. Although described as microgrids, the present disclosure contemplates management computing system 202 managing other suitable types of entities.

System 200 includes external information sources 208. External information sources 208 may be the same as and/or may share certain or all features in common with external information sources 108 of FIG. 1. In the illustrated example, system 200 includes external environmental sources 208a, which may provide environmental data. System 200 also includes external economic sources 208b, which may provide economic data.

System 200 includes abstraction layer 210. Abstraction layer 210 may be the same as and/or may share certain or all features in common with abstraction layer 110 of FIG. 1. As describe above with respect to abstraction layer 110, abstraction layer 210 may be implemented in a variety of ways. In certain embodiments, abstraction layer 210 implements a SOA that facilitates communication between management computing system 202 and the management computing systems 102 of heterogeneous microgrids 250. A portion or all of abstraction layer 210 may be implemented using management computing system 210 and management computing systems 110 of microgrids 250. The abstracted messaging format implemented by abstraction layer 210 may be the same as or different than the abstracted messaging format implemented by abstraction layers 110 of individual microgrids 250.

System 200 includes storage module 212. Storage module 212 may be the same as and/or may share certain or all features in common with storage module 212 of FIG. 1. Storage module 212 stores power management data 248 related to multiple microgrids 250. Additionally or alternatively, storage module 212 may store configuration parameters 264, operating parameters 266, and simulation results 168 for modeling and simulating multiple microgrids, some or all of which may include one or more physical microgrids 250.

In operation of an example embodiment of system 200, power management tool 218 is operable to administer the operation of microgrids 250 based on power management data 248 received from microgrids 250 and/or external information sources 208. For example, power management tool 218 may analyze power management data 248 according to one or more algorithms 220 and policies 224, and may determine whether to perform one or more actions based on the analysis and if so, what one or more actions to perform. Power management tool 218 may be able to perform some or all of these actions substantially autonomically, without requiring the input of a human user, thereby providing smart, autonomous management of heterogeneous types of microgrids 250. The power management data received from microgrids 250 (e.g., operational data) and external information sources 208 (e.g., environmental data and/or economic data) may be translated from a format associated with their native elements into an abstract format implemented using abstraction layer 210.

System 200 may include orchestration engine 260. Orchestration engine 260 may be the same as and/or may share certain or all features in common with orchestration engine 160 of FIG. 1. In general, FIG. 2 illustrates that orchestration engine 260 may consider and involve multiple, heterogeneous physical microgrids 250 as part of the simulation of an evaluated power environment.

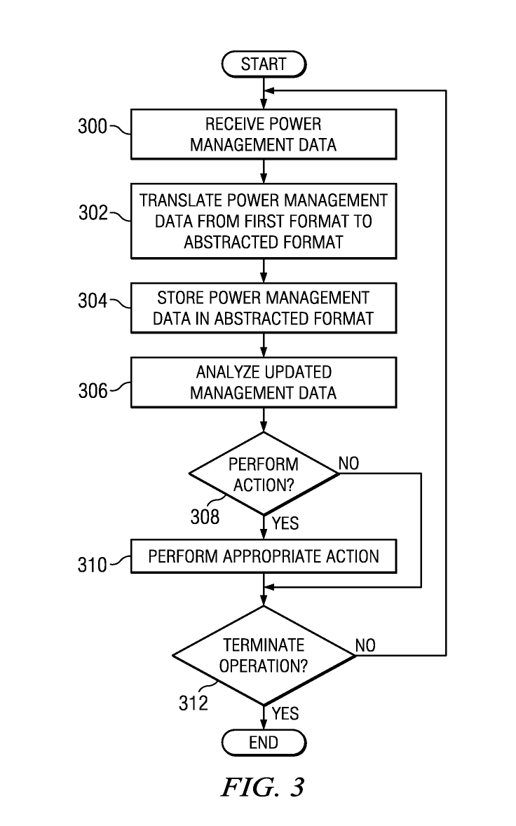

FIG. 3 illustrates an example method for managing a power environment according to certain embodiments of the present disclosure. This example method will be described with reference to FIG. 1. For purposes of this example, it will be assumed that both management computing system 102 and computer system 138 of power environment 138 implement abstraction layer 110.

At step 300, power management tool 118 may receive power management data. Power management data may be received in any suitable manner, according to particular needs. For example, power management tool 118 may poll computer system 138 for power management data. Computing system 138 may gather power operational or other data from elements of power environment 106 in any suitable manner. Additionally or alternatively, computer system 138 may communicate power management data to power management tool 118 on a scheduled or other basis.

At step 302, power management tool 118 may translate the collected power management data from a first format to a second, abstracted format. For example, the first format may be a format native to power environment 106 and/or the particular element or elements to which the power management data relates. As a particular example, power management tool 118 may translate operational data from a first format associated with power environment 106 to an abstracted format associated with abstraction layer 110. Additionally or alternatively, power management tool 118 may translate external data from a format associated with a corresponding external information source (e.g., the external information source from which the external data was received) to an abstracted format associated with abstraction layer 110.

In certain embodiments, rather than power management tool 118 translating the collected power management data from the first format to the second, abstracted format, computer system 138 may translate the power management data from the first format to the second, abstracted format prior to communicating the power management data to power management tool 118. For example, computer system 138 may include one or more adapters operable to perform this translation.

At step 304, management computing system 102 may store the power management data in the abstracted format in storage module 112. For example, power management tool 114 may store the translated power management data in storage module 112 as power management data 148. This power stored power management data may be an update to existing power management data or may be new power management data not previously stored in storage module 112. In certain embodiments, power management data 148 is stored in one or more objects of storage module 112.

At step 306, management computing system 102 may analyze a portion or all of power management data 148 stored in storage module 112. For example, power management tool 118 may analyze a portion or all of the updated power management data 148 using one or more algorithms 120 and according to one or more policies 124. Among other things, these algorithms 120 may specify when certain actions should be initiated by power management tool 118. As described above, these algorithms 120 may consider as inputs a variety of power management data 148, including operational data associated with power environment 106 and external data received from external information sources 108 (e.g., environmental data received from environmental sources 108a and economic data received from economic sources 108b).

At step 308, management computing system 102 (e.g., power management tool 118) may determine whether to perform an action in response to the analysis performed at step 306. In certain embodiments, step 308 may be a result of the analysis described above in step 306 such that the determination at step 308 is inherent in the analysis performed at step 306. Certain example actions are described below.

As a first example, management computing system 102 (e.g., power management tool 118) may determine whether to update GUI 126 based on the analysis of the updated power management data 148. This update may simply be to display more up-to-date status or other information related to the operation and/or configuration of power environment 106. In certain scenarios, this update may display one or more alerts based on the analysis of the updated power management data 148.

As a second example, management computing system 102 (e.g., power management tool 118) may determine whether to issue one or more alerts based on the analysis of the updated power management data 148. For example, issuing an alert may including causing a suitable component of management computing system 102 (e.g., power management tool 118) to communicate a message to one or more individuals or systems to notify the individuals or systems of an alert condition. The message may include any suitable any suitable combination of types of messages such as e-mails, text messages, telephone calls, and alarms. The message may include any suitable information, such as an indication of the alert condition and any suitable context information (e.g., operational conditions or environmental or economic conditions), according to particular needs. This alert could be communicated in response to detecting an emergency (or possible/impending emergency) situation or for any other suitable reason (e.g., according to policies 124).

As a third example, management computing system 102 (e.g., power management tool 118) may determine whether to issue one or more commands based on the analysis of the updated power management data 148. As described above, these commands may include a command to adjust a status of one or more elements of power environment 106, turn on one or more elements of power environment 106, turn off one or more elements of power environment 106, or to perform other suitable actions. In certain embodiments, these commands are communicated from power management tool 118 of management computing system 102 to computer system 138 of power environment 106.

Although the present disclosure contemplates commands being issued in any suitable manner, in certain embodiments, power management tool 118 determines that a command should be issued based on the analysis of the updated power management data 148. Power management tool 118 may interact with command and control module 122 to cause command and control module 122 to issue one or more commands, and in response to this interaction, command and control module 122 may issue the one or more commands.

Command and control module 122 may or may not communicate in the abstracted language of adaptation layer 104. In situations in which command and control module 122 does not communicate in the abstracted language of adaptation layer 104, adaptation layer 104 may translate commands or other messages communicated by command and control module 122 to the abstracted format implemented by adaptation layer 104. For example, one or more adapters associated with management computing system 102 may translate commands or other messages communicated by command and control module 122 to the abstracted format implemented by adaptation layer 104.

It may also be appropriate to translate the commands from the abstracted format to a format understandable to a target element of power environment 106. For example, the element of power environment 106 whose operational status the command is intended to affect may not understand the abstracted format in which the command is communicated. Thus, a suitable component (e.g., an adapter associated with adaptation layer 104 stored on computer system 138) may translate the command from the abstracted format to a format understandable to the target element of power environment 106. Computer system 138 or another suitable component of power environment 106 then may deliver the translated command to the target element.

If power management tool 118 determines at step 308 that, based on the analysis of power management data 148 at step 306, that an action should be performed, then at step 310 power management tool 118 may initiate performance of an appropriate action. As described above, example actions may include any suitable combination of updating GUI 126, issuing one or more alerts, issuing one or more commands, and performing any other suitable action(s).

At step 312, management computing system 102 may determine whether operation should be terminated. If management computing system 102 determines at step 310 that operation should be terminated, then method may end. If management computing system 102 determines at step 310 that operation should not be terminated, then the method may return to step 300 to await receipt of new data. Although returning to step 300 is described, the program and/or computer system performing this method (e.g., power management tool 118) may enter a waiting state in which the program and/or computer system simply waits for input, whether that input.

Other process flows are contemplated by the present disclosure. For example, management computing system 102 may update the user interface in response to a request from a user of management computing system 102. As another example, management computing system 102 may issue a command in response to a request from a user of management computing system 102.

While the above method has been described primarily with respect to a management computing system 102 managing a single power environment (e.g., power environment 106), as described above, the present disclosure contemplates a management computing system (e.g., management computing system 202) managing multiple microgrids 150/250.

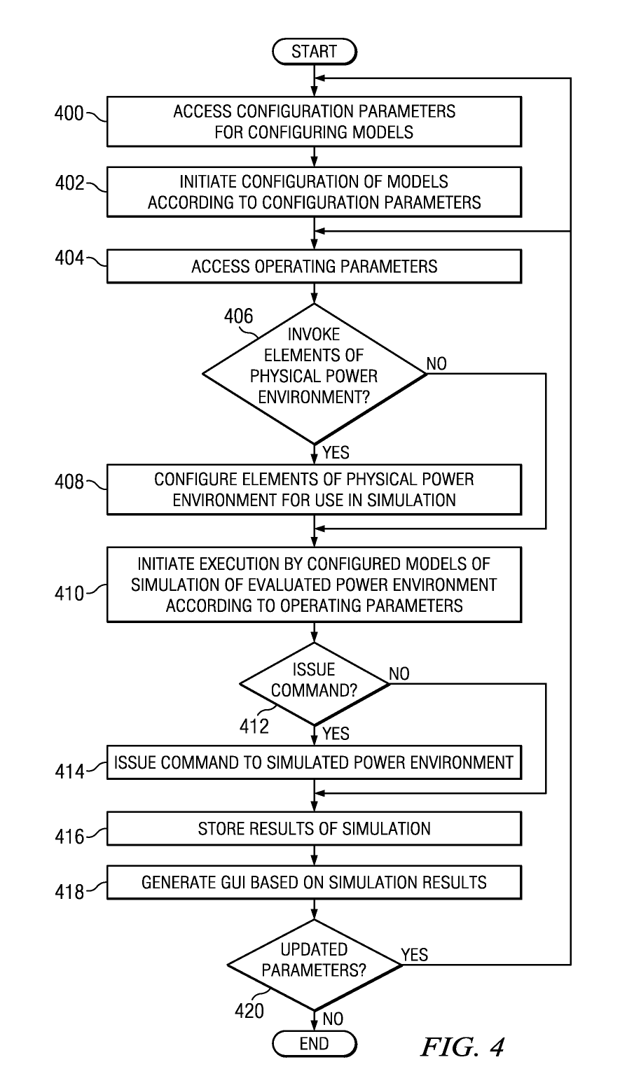

FIG. 4 illustrates an example method for modeling and simulating a power environment according to certain embodiments of the present disclosure. At step 400, orchestration engine 160 accesses configuration parameters 164 for configuring models 162 that are operable to simulate operation of a power environment (e.g., an evaluated power environment). For example, orchestration engine may receive configuration parameters 164 from a user of management computing system 102, and may store the received configuration parameters 164 in a suitable location, such as storage module 112. If appropriate orchestration engine 160 may invoke abstraction layer 110 to translate configuration parameters 164 from the format in which they are received from the user to an abstracted format for storage in storage module 112. Orchestration engine 160 may access configuration parameters 164 (e.g., from storage module 112) in any suitable manner.

A first subset of models 162 models power environment elements of the evaluated power environment. A second subset of models 162 models one or more external information sources 108. As describe above, external information sources may include environmental sources 108a, economic sources 108b, and/or any other suitable external information sources.

At step 402, orchestration engine 160 may initiate configuration of models 206 according to configuration parameters 164. This may result in what may be referred to as configured models 162.

At step 404, orchestration engine 160 may access operating parameters 166, which may indicate operating conditions for models 162 to simulate in order to simulate the evaluated power environment. For example, orchestration engine 160 may receive operating parameters 166 from a user of management computing system 102, and may store the received operating parameters 166 in a suitable location, such as storage module 112. If appropriate orchestration engine 160 may invoke abstraction layer 110 to translate operating parameters 166 from the format in which they are received from the user to an abstracted format for storage in storage module 112. Orchestration engine 160 may access operating parameters 166 (e.g., from storage module 112) in any suitable manner.

At step 406, orchestration engine 160 may determine whether to invoke elements of any physical power environment 106. If orchestration engine 160 determines that elements of a physical power environment 106 should be invoked, then at step 408 orchestration engine 160 may configure the elements of the physical power environment 106 for use in the simulation. For example, orchestration engine may communicate with computer system 138 of power environment 106, possibly using abstraction layer and potentially via power management tool 118, to configure the elements of physical power environment 106 for participation in the simulation of the evaluated power environment. It should be noted that the present disclosure contemplates physical power environment 106 being the entire evaluated power environment, if appropriate.

If orchestration engine 160 determines at step 406 that elements of a physical power environment 106 should be invoked, then the method may proceed to step 410.

At step 410, orchestration engine 160 may initiate execution by the configured models 162 of a simulation of the evaluated power environment according to operating parameters 166. The configured models 162 may interact to execute the simulation. For example, the configured models 162 may communicate intermediate results and simulations with one another to complete provide the simulation of the evaluated power environment. The simulation of the evaluated power environment may provide an indication of how the simulated (evaluated) power environment behaves according to operating parameters 166.

At step 412, orchestration engine 160 may determine whether to issue one or more commands to the evaluated power environment under simulation. For example, orchestration engine 160 may receive one or more commands from a user of management computing system 102. As another example, one or more of models 162 invoked as part of the simulation may autonomically request issuance of a command.

If orchestration engine 160 determines at step 412 to issue a command, then at step 414 orchestration engine 160 may initiate issuance of a command to the evaluated power environment being simulated. In certain embodiments, orchestration engine 160 may issue commands by invoking power management tool 118 (e.g., command and control module 122) to issue the commands. Commands may be issued in an abstracted format using abstraction layer 110, when a physical power environment 106 is involved in the simulation for example. If orchestration engine 160 determines at step 412 not to issue a command, then the method may continue to step 416.

At step 416, orchestration engine 160 may store the results of the simulation of the evaluated power environment. For example, the results may be stored as simulation results 168 in storage module 112. Simulation results 168 may be stored in any suitable format, such as in one or more software objects.

At step 418, orchestration engine 160 may generate a GUI 126 based on simulation results 168. Additionally or alternatively, orchestration engine 160 may generate GUI 126 to include a representation of configuration parameters 164 and/or operating parameters 166. Generating GUI 126 may include generated an initial GUI 126 or updating an existing GUI 126. The simulation of the evaluated power environment, possibly in conjunction with GUI 126, may provide an indication of how the simulated, evaluated power environment behaves according to the operating parameters, commands, and/or other factors.

At step 420, orchestration engine 160 may determine whether it has received update parameters. For example, orchestration engine 160 may determine whether it has received updated configuration parameters 164 and/or updated operating parameters 166. As a particular example, a user of management computing system 102 may view GUI 126 and determine that the simulated power environment did not perform as expected and/or desired. The user may then interact with orchestration engine 160 (e.g., via GUI 126) to update one or more of configuration parameters 164 and/or operating parameters 166.

If orchestration engine 160 determines that it has received updated parameters, then the method may return to step 300 and/or step 404, depending on the type of updated parameters received. Ultimately, orchestration engine 160 may return to step 410 to initiate regeneration of the simulated power environment according to the updated parameters. If orchestration engine 160 determines at step 416 that it has not received updated parameters, then the method may end.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. A system, comprising:
one or more memory modules; and
one or more processing units operable to:
access configuration parameters for configuring a plurality of models operable to simulate operation of a power environment, a first subset of the plurality of models modeling power environment elements of the power environment and a second subset of the plurality of models modeling one or more external information sources, a first external information source comprising an environmental source operable to provide environmental data;
initiate configuration of the plurality of models according to the configuration parameters, resulting in a configured plurality of models;
access operating parameters indicating operating conditions for the plurality of models to simulate; and
initiate execution by the configured plurality of models of a simulation of the power environment according to the operating parameters, the configured plurality of models interacting to execute the simulation, the simulation providing an indication of how the simulated power environment behaves according to the operating parameters.

2. The system of claim 1, wherein the configuration parameters indicate a set of power environment elements to be included in the power environment.

3. The system of claim 1, wherein the operating parameters comprise an indication of a simulation time period for simulating operation of the power environment, the indication of how the simulated power environment behaved comprising an indication of how the simulated power environment behaved over the simulated time period.

4. The system of claim 1, wherein the one or more processing units are further operable to incorporate a physical, operating power environment in simulating at least a portion of the power environment.

5. The system of claim 1, wherein the environmental data comprises one or more of:
past weather data;
current weather data; and
forecasted weather data.

6. The system of claim 1, wherein the one or more external information sources comprise one or more of the following:
a first economic source providing cost information; and
a second economic source providing feed-in-tariff information.

7. The system of claim 1, wherein:
the one or more processing units are operable to communicate a command to affect operation of the simulated power environment; and
the execution by the configured plurality of models of the simulation of the power environment according to the operating parameters further comprises simulating execution of the command in the simulated power environment by causing the simulated power environment to adjust operation according to the command.

8. The system of claim 1, wherein the one or more processing units are operable to generate a graphical user interface, the generated graphical user interface displaying information related to the simulation power environment, the information comprising an indication of how the simulated power environment behaved according to the operating parameters.

9. The system of claim 1, wherein the power environment comprises one or more of:
a power environment under design; and
a power environment under test.

10. The system of claim 1, wherein the one or more processing units are operable to:
access updated parameters comprising one or more of the following:
updated configuration parameters; and
updated operating parameters; and
reinitiate execution of the simulation of the power environment according to the updated parameters, the simulation providing an indication of how the simulated power environment behaves according to the updated parameters.

11. Software embodied on non-transitory computer-readable media and when executed using one or more processing units operable to perform operations comprising:
accessing configuration parameters for configuring a plurality of models operable to simulate operation of a power environment, a first subset of the plurality of models modeling power environment elements of the power environment and a second subset of the plurality of models modeling one or more external information sources, a first external information source comprising an environmental source operable to provide environmental data;
initiating configuration of the plurality of models according to the configuration parameters, resulting in a configured plurality of models;
accessing operating parameters indicating operating conditions for the plurality of models to simulate; and
initiating execution by the configured plurality of models of a simulation of the power environment according to the operating parameters, the configured plurality of models interacting to execute the simulation, the simulation providing an indication of how the simulated power environment behaves according to the operating parameters.

12. The software of claim 11, wherein the configuration parameters indicate a set of power environment elements to be included in the power environment.

13. The software of claim 11, wherein the operating parameters comprise an indication of a simulation time period for simulating operation of the power environment, the indication of how the simulated power environment behaved comprising an indication of how the simulated power environment behaved over the simulated time period.

14. The software of claim 11, wherein the software when executed using the one or more processing units is further operable to incorporate a physical, operating power environment in simulating at least a portion of the power environment.

15. The software of claim 11, wherein the environmental data comprises one or more of:
past weather data;
current weather data; and
forecasted weather data.

16. The software of claim 11, wherein the one or more external information sources comprise one or more of the following:
a first economic source providing cost information; and
a second economic source providing feed-in-tariff information.

17. The software of claim 11, wherein:
the software when executed using the one or more processing units is further operable to communicate a command to affect operation of the simulated power environment; and
the execution by the configured plurality of models of the simulation of the power environment according to the operating parameters further comprises simulating execution of the command in the simulated power environment by causing the simulated power environment to adjust operation according to the command.

18. The software of claim 11, wherein the software when executed using the one or more processing units is further operable to generate a graphical user interface, the generated graphical user interface displaying information related to the simulation power environment, the information comprising an indication of how the simulated power environment behaved according to the operating parameters.

19. The software of claim 11, wherein the power environment comprises one or more of:
a power environment under design; and
a power environment under test.

20. The software of claim 11, wherein the software when executed using the one or more processing units is further operable to:
access updated parameters comprising one or more of the following:
updated configuration parameters; and
updated operating parameters; and
reinitiate execution of the simulation of the power environment according to the updated parameters, the simulation providing an indication of how the simulated power environment behaves according to the updated parameters.

21. A computer-implemented method, comprising:
accessing, using one or more processing units, configuration parameters for configuring a plurality of models operable to simulate operation of a power environment, a first subset of the plurality of models modeling power environment elements of the power environment and a second subset of the plurality of models modeling one or more external information sources, a first external information source comprising an environmental source operable to provide environmental data;
initiating, using the one or more processing units, configuration of the plurality of models according to the configuration parameters, resulting in a configured plurality of models;
accessing, using the one or more processing units, operating parameters indicating operating conditions for the plurality of models to simulate; and
initiating, using the one or more processing units, execution by the configured plurality of models of a simulation of the power environment according to the operating parameters, the configured plurality of models interacting to execute the simulation, the simulation providing an indication of how the simulated power environment behaves according to the operating parameters.
